(19) United States
(12) Patent Application Publication
(10) Pub. No.: US 2013/0265289 A1
(43) Pub. Date: Oct. 10, 2013

(54) CHOLESTERIC LIQUID CRYSTAL DISPLAY DEVICE AND METHOD FOR DRIVING THE SAME

(71) Applicants: Yu-Hsien CHEN, Kaohsiung City (TW); Huang-Ming Chen, Hsinchu County (TW); Sheng-Fa Liu, Taoyuan (TW); Mei-Tsao Chiang, Taoyuan County (TW); Bao-Sian Ciou, New Taipei City (TW)

(72) Inventors: Yu-Hsien CHEN, Kaohsiung City (TW); Huang-Ming Chen, Hsinchu County (TW); Sheng-Fa Liu, Taoyuan (TW); Mei-Tsao Chiang, Taoyuan County (TW); Bao-Sian Ciou, New Taipei City (TW)

(73) Assignee: CHUNGHWA PICTURE TUBES, LTD., National Chiao Tung University

(21) Appl. No.: 13/613,521

(22) Filed: Sep. 13, 2012

(30) Foreign Application Priority Data
Apr. 9, 2012 (TW) 101112417

(51) Int. Cl. G02F 1/1337; G06F 3/038

(52) U.S. Cl. 345/211; 349/123

(57) ABSTRACT

A cholesteric liquid crystal display device includes a first substrate, a second substrate, a cholesteric liquid crystal layer and a plurality of nano particles. The first substrate includes a first alignment layer. The second substrate includes a second alignment layer. The cholesteric liquid crystal layer is disposed between the first and second alignment layers. The nano particles are disposed on a surface of one of the first and second alignment layers, and located between the one of the first and second alignment layers and the cholesteric liquid crystal layer.

### CROSS-REFERENCE TO RELATED APPLICATION

This application claims the benefit of Taiwan Patent Application No. 101112417, filed on Apr. 9, 2012, which is hereby incorporated by reference for all purposes as if fully set forth herein.

### BACKGROUND OF THE INVENTION

1. Field of Invention

This invention relates to a cholesteric liquid crystal display device, and more particularly to a cholesteric liquid crystal display device, which can be operated within the low driving voltage range, thereby adjusting the gray-level of the cholesteric liquid crystal display device.

2. Related Art

Referring FIG. 1, a conventional reflective cholesteric liquid crystal display (Ch-LCD) device 10 mainly includes a transparent glass 11, a plurality of liquid crystal units 12 and a light-absorbing glass 13. When a voltage is applied to the Ch-LCD device 10, the liquid crystal units 12 can show an image (shown in the intermediate drawing of FIG. 1) according to a signal sequence of the applied voltage. The Ch-LCD device 10 has two stable states: a planar state and a focal conic state.

The planar state is a bright state, i.e., the liquid crystal units 12 have cholesteric liquid crystals which are regularly arranged by means of a planar twisted texture (shown in the lower left drawing of FIG. 1), whereby a half of an ambient light can be reflected when the ambient light passes through the transparent glass 11, the liquid crystal units 12 and the light-absorbing glass 13. Thus, the Ch-LCD device 10 is generally applicable in electronic books, etc. When the Ch-LCD device 10 are requested to often switch a picture frame to another picture frame and the Ch-LCD device 10 has no the applied voltage, the Ch-LCD device 10 can utilizes the ambient light to show the image so as to save the energy.

The focal conic state is a dark state, i.e., the liquid crystal units 12 have cholesteric liquid crystals which are irregularly arranged by means of a focal conic texture (shown in the lower right drawing of FIG. 1), whereby an ambient light can pass through the transparent glass 11, is scattered by the liquid crystal units 12, and is fully absorbed by the light-absorbing glass 13. According to the signal of the applied voltage, the stable state of the Ch-LCD device 10 can be the planar state or the focal conic state.

Referring to FIG. 2, it depicts the relationship (R-V curve) between the reflection and the voltage of the conventional Ch-LCD device. A driving voltage range is between first and second voltages V1, V2 and third and fourth voltages V3, V4, and is adapted to control the gray-level of the cholesteric liquid crystals. However, according to the restriction of the property of the cholesteric liquid crystals, the cholesteric liquid crystals must be switched to the planar state (i.e., bright state) by a reset voltage V_{R} (i.e., the reset voltage V_{R} is higher than the fourth voltage V₄) during the switch of the gray-level. In other words, before each switch of the gray-level, the cholesteric liquid crystals must be switched to the initial planar state (i.e., bright state) by the reset voltage V_{R} having a high voltage.

Generally, the gray-level of the cholesteric liquid crystals is switched by using driving voltages of the third to fourth voltages V3-V4 together with the reset voltage V_{R}. However, the slope of the reflection corresponding to the third to fourth voltages V3-V4 is too steep to easily switch of the gray-level.

Accordingly, there exists a need for a cholesteric liquid crystal display device capable of solving the above-mentioned problems.

### SUMMARY OF THE INVENTION

It is one object of the present invention to adjust the gray-level of a cholesteric liquid crystal display device by utilizing the magnitude of the driving voltage within the low driving voltage range.

The present invention provides a cholesteric liquid crystal display device including a first substrate, a second substrate, a cholesteric liquid crystal layer and a plurality of nano particles. The first substrate includes a first alignment layer. The second substrate includes a second alignment layer. The cholesteric liquid crystal layer is disposed between the first and second alignment layers. The nano particles are disposed on a surface of one of the first and second alignment layers, and located between the one of the first and second alignment layers and the cholesteric liquid crystal layer.

The present invention further provides a method for driving a cholesteric liquid crystal display device comprising the following steps of: providing a cholesteric liquid crystal display device, wherein the cholesteric liquid crystal display device comprises a first substrate, a second substrate, a cholesteric liquid crystal layer and a plurality of nano particles, the first substrate comprises a first alignment layer, the second substrate comprises a second alignment layer, the cholesteric liquid crystal layer is disposed between the first and second alignment layers, the nano particles are located between the first alignment layer and the cholesteric liquid crystal layer and/or between the second alignment layer and the cholesteric liquid crystal layer; and applying a driving voltage to the cholesteric liquid crystal layer, wherein: the cholesteric liquid crystal layer is in a first state when the driving voltage is a first voltage; the cholesteric liquid crystal layer is in a second state when the driving voltage is increased and changed to a second voltage; the cholesteric liquid crystal layer comes back to the initial first state when the driving voltage is decreased and changed to be the first voltage; and when the cholesteric liquid crystal layer is operated within a driving voltage range between the first voltage and the second voltage, the driving voltage can be increased or decreased in two-way operating direction, whereby the first state and the second state are mixed, and the ratio of the first state to the second state is different so as to show the gray-level of the cholesteric liquid crystal display device.

According to the cholesteric liquid crystal display device of the present invention, the cholesteric liquid crystal layer can be only operated within the low driving voltage range between the first and second voltages without the reset voltage, thereby adjusting the gray-level of the cholesteric liquid crystal display device.

In order to make the aforementioned and other objectives, features and advantages of the present invention comprehensible, embodiments are described in detail below with reference to the accompanying drawings.

### BRIEF DESCRIPTION OF THE DRAWINGS

FIG. 1 is a partially perspective schematic view of a conventional cholesteric liquid crystal display device, which has a planar state and a focal conic state and shows an image according to a signal sequence of the applied voltage;

FIG. 2 is a schematic view showing the relationship between the reflection and the voltage of a conventional cholesteric liquid crystal display device;

FIGS. 3a and 3b are partially perspective schematic views of a cholesteric liquid crystal display device according to an embodiment of the present invention;

FIG. 4 is a cross-sectional schematic view of a cholesteric liquid crystal layer, a first alignment layer and a second alignment layer of the cholesteric liquid crystal display device according to an embodiment of the present invention;

FIG. 5 is a cross-sectional schematic view of a cholesteric liquid crystal layer, a first alignment layer and a second alignment layer of the cholesteric liquid crystal display device according to another embodiment of the present invention;

FIG. 6 is a cross-sectional schematic view of a cholesteric liquid crystal layer, a first alignment layer and a second alignment layer of the cholesteric liquid crystal display device according to a further embodiment of the present invention;

FIG. 7 is a flow diagram showing a method for driving a cholesteric liquid crystal display device according to an embodiment of the present invention; and

FIG. 8 is a schematic view showing the relationship between the reflection and the voltage of a cholesteric liquid crystal display device according to an embodiment of the present invention.

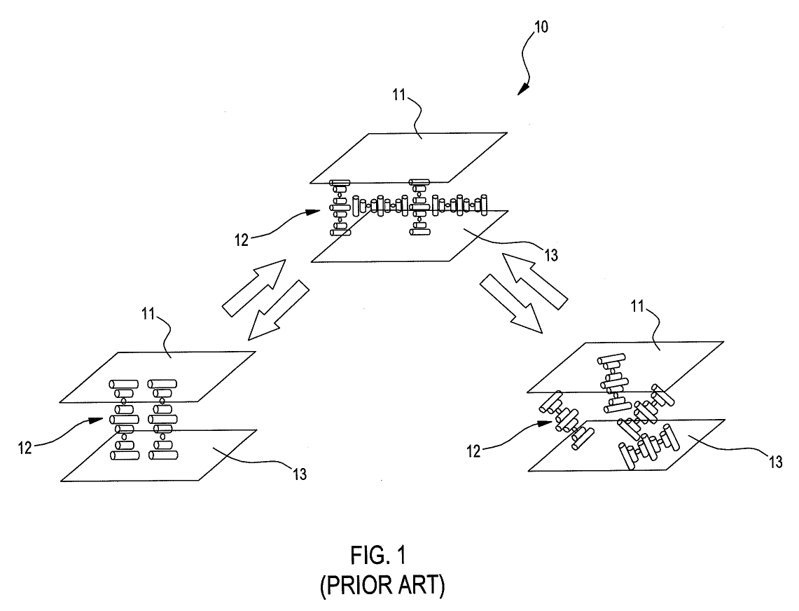

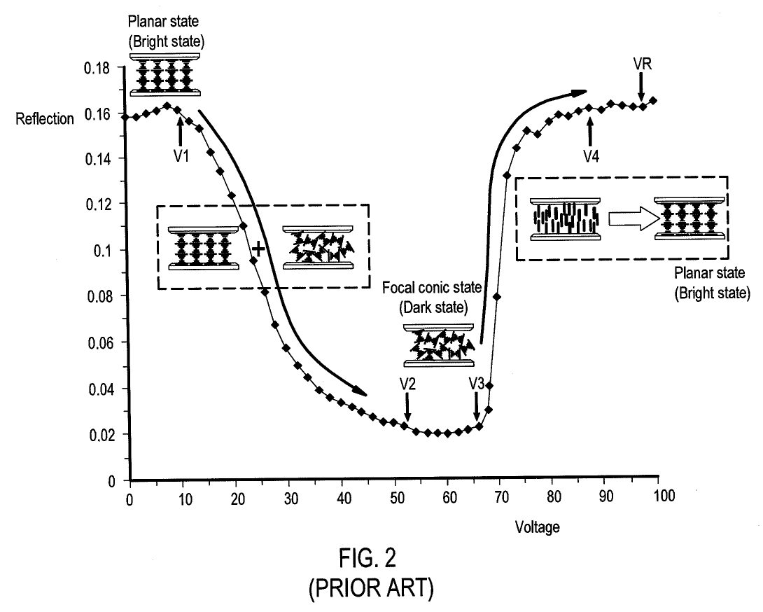

The present invention will become more fully understood from the detailed description given herein below for illustration only, and thus are not limitative of the present invention, and wherein:

### DETAILED DESCRIPTION OF THE INVENTION

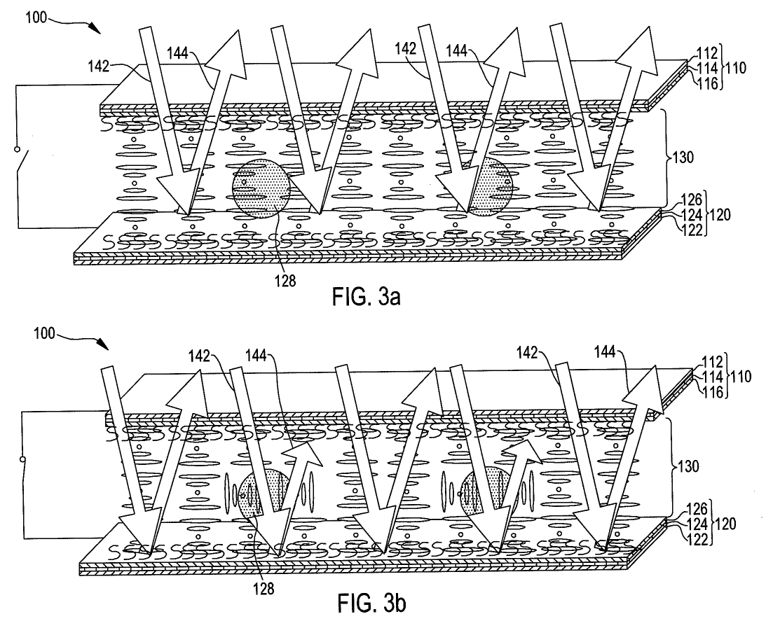

Referring to FIGS. 3a and 3b, they depict a cholesteric liquid crystal display (Ch-LCD) device 100 according to an embodiment of the present invention. The Ch-LCD device 100 includes a first substrate 110, a second substrate 120 and a cholesteric liquid crystal layer 130. The first substrate 110 includes a first transparent substrate 112, a transparent common electrode 114 and a first alignment layer 116. The transparent common electrode 114 is disposed on a surface of the first transparent substrate 112, and the first alignment layer 116 is disposed on a surface of the transparent common electrode 114.

The second substrate 120 includes a second transparent substrate 122, a transparent pixel electrode 124 and a second alignment layer 126. The transparent pixel electrode 124 is disposed on a surface of the second transparent substrate 122, and the second alignment layer 126 is disposed on a surface of the transparent pixel electrode 124. The second substrate 120 further includes circuit element, e.g., thin film transistors and capacitors (not shown).

The cholesteric liquid crystal layer 130 is disposed between the first and second alignment layers 116, 126. Briefly, a polymide (PI) is coated on the first substrate 110, and then the polymide can be acted as the first alignment layer 116 after a rubbing arrangement process. A polymide (PI) is coated on the second substrate 120, and then the polymide can be acted as the second alignment layer 126 after a rubbing arrangement process. The second substrate 120 is attached to the first substrate 110, and then the cholesteric liquid crystals are injected between the first and second alignment layers 116, 126. A voltage between the transparent common electrode 114 and the transparent pixel electrode 124 can determine a driving voltage of the cholesteric liquid crystal layer 130.

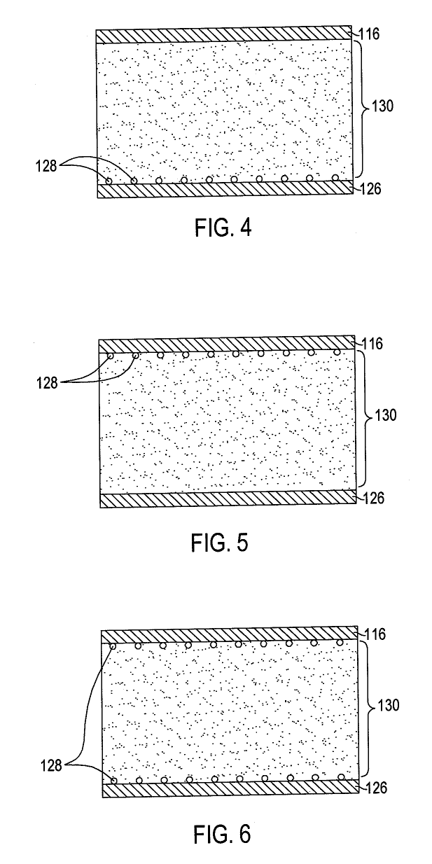

Referring FIG. 4, in this embodiment, the Ch-LCD device 100 further includes a plurality of nano particles 128, which are disposed on a surface of the second alignment layer 126, and located between the second alignment layer 126 and the cholesteric liquid crystal layer 130.

Referring FIG. 5, in another embodiment, the Ch-LCD device 100 further includes a plurality of nano particles 128, which are disposed on a surface of the first alignment layer 116, and located between the first alignment layer 116 and the cholesteric liquid crystal layer 130.

Referring FIG. 6, in a further embodiment, the Ch-LCD device 100 further includes a plurality of nano particles 128, which are disposed on surfaces of the first and second alignment layers 116, 126, and located between the first alignment layer 116 and the cholesteric liquid crystal layer 130 and between the second alignment layer 126 and the cholesteric liquid crystal layer 130.

The nano particles 128 can be made of silica (SiO₂) or nano silver ink. The nano particles 128 can be in the spherical shape. The nano particles 128 can be uniformly distributed on the alignment layer (which is made of polymide) by a sprinkling process or an ink spraying process. After the sprinkling process or the ink spraying process, the nano particles 128 can be attached on the alignment layer by a pre-baking process. The pre-baking temperature can be within a range between 120 and 180 degrees Celsius, and the pre-baking time can be within a range between 10 and 40 minutes. Preferably, the nano particle 128 includes a layer located on a surface thereof, the layer is made of poly acrylic resin. After the poly acrylic resin is heated, the nano particles 128 can be attached on the alignment layer.

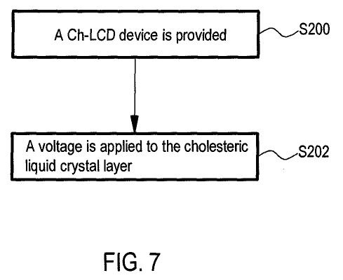

Referring to FIG. 7, it depicts a method for driving a cholesteric liquid crystal display (Ch-LCD) device according to an embodiment of the present invention. In step S200, a Ch-LCD device 100 is provided, wherein the Ch-LCD device 100 includes a first substrate 110, a second substrate 120, a cholesteric liquid crystal layer 130 and a plurality of nano particles 128, the first substrate 110 includes a first alignment layer 116, the second substrate 120 includes a second alignment layer 126, the cholesteric liquid crystal layer 130 is disposed between the first and second alignment layers 116, 126, the nano particles 128 are disposed on a surface of the second alignment layer 126, and located between the second alignment layer 126 and the cholesteric liquid crystal layer 130, shown in FIG. 3a.

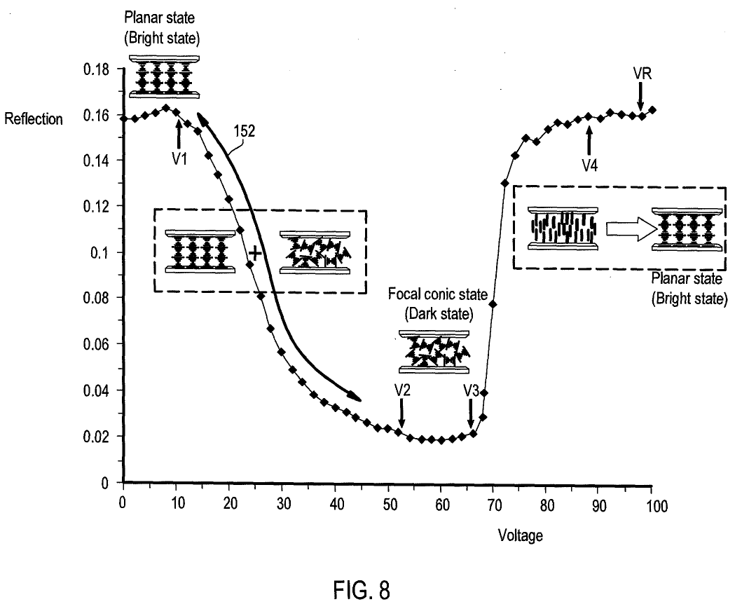

In step S202, a driving voltage is applied to the cholesteric liquid crystal layer 130. The cholesteric liquid crystal layer 130 is in a first state when the driving voltage is a first voltage V1. The cholesteric liquid crystal layer 130 is in a second state when the driving voltage is increased and changed to a second voltage V2 (wherein V2 is higher than V1). The cholesteric liquid crystal layer 130 comes back to the initial first state when the driving voltage is decreased and changed to be the first voltage V1. The first and second states are a planar state and a focal conic state respectively, and the planar state and the focal conic state are a bright state and a dark state respectively. When the cholesteric liquid crystal layer 130 is operated within a driving voltage range between the first voltage V1 and the second voltage V2, the driving voltage can be increased or decreased in the two-way operating direction (shown as the two-way arrow 152), whereby the first state and the second state are mixed, and the ratio of the first state to the second state is different so as to show the gray-level of the Ch-LCD device 100, shown in FIG. 8. At this moment, the cholesteric liquid crystals have no property of two stable states.

More detailed, the cholesteric liquid crystals located at the neighborhood of the nano particles 128 starts to transfer different state when the voltage is applied to the cholesteric liquid crystals; but the cholesteric liquid crystals can come back to the initial state: the planar state (i.e., bright state) when the voltage is not applied to the cholesteric liquid crystals. At this moment, the cholesteric liquid crystals are operated within the driving voltage range between the first voltage V1 and the second voltage V2 shown in FIG. 8.

The present invention can utilize the magnitude of the driving voltage within the driving voltage range between the first voltage V1 and the second voltage V2 to adjust the gray-level of the Ch-LCD device 100. Preferably, in this embodiment, the nano particles 128 can be disposed on the surface of the second alignment layer 126 and have a distribution density of 1 to 100 per square micrometer, and the size of the nano particle 128 can be between 20 and 1000 nanometers so as to effectively prevent parts of the cholesteric liquid crystals from the influence of the second alignment layer 126.

Referring to FIG. 3a, the cholesteric liquid crystals are in the planar state (i.e., bright state) when the voltage is not applied to the cholesteric liquid crystals. According to the restriction of the optical rotation of the cholesteric liquid crystals, only 50% of an ambient light 142 can be reflected by the cholesteric liquid crystals after 100% of the ambient light 142 enters the Ch-LCD device 100. In other words, left-handed cholesteric liquid crystals reflect left-handed reflected light 144. At this moment, the cholesteric liquid crystals is affected by an arranging force of the arrangement layer, and then the cholesteric liquid crystals of the Ch-LCD device 100 are arranged in the bright state.

Referring to FIG. 3b, the cholesteric liquid crystals located at the neighborhood of the nano particles 128 are changed to be in the focal conic state (i.e., dark state) after the voltage is applied to the cholesteric liquid crystals. At this moment, the arranging force of the arrangement layer only affects and holds the cholesteric liquid crystals located at a periphery region far away from the nano particles 128. The cholesteric liquid crystals located at a center region adjacent to the nano particles 128 are gradually changed to be in the focal conic state (i.e., dark state) according to the magnitude of the driving voltage. The state change of the cholesteric liquid crystals depends on the magnitude of the driving voltage.

According to the Ch-LCD device of the present invention, the cholesteric liquid crystal layer can be only operated within the low driving voltage range between the first and second voltages without the reset voltage, thereby adjusting the gray-level of the Ch-LCD device.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A cholesteric liquid crystal display device comprising:
a first substrate comprising a first alignment layer;
a second substrate comprising a second alignment layer;
a cholesteric liquid crystal layer disposed between the first and second alignment layers; and
a plurality of nano particles disposed on a surface of one of the first and second alignment layers, and located between the one of the first and second alignment layers and the cholesteric liquid crystal layer.

2. The cholesteric liquid crystal display device as claimed in claim 1, wherein the nano particles are disposed on a surface of the other one of the first and second alignment layers, and located between the other one of the first and second alignment layers and the cholesteric liquid crystal layer.

3. The cholesteric liquid crystal display device as claimed in claim 1, wherein the nano particles are disposed on the surface of the second alignment layer and have a distribution density of 1 to 100 per square micrometer.

4. The cholesteric liquid crystal display device as claimed in claim 1, wherein the size of the nano particle is between 20 and 1000 nanometers.

5. The cholesteric liquid crystal display device as claimed in claim 1, wherein the nano particles are in the spherical shape.

6. The cholesteric liquid crystal display device as claimed in claim 1, wherein the nano particles are made of silica (SiO₂) or nano silver ink.

7. The cholesteric liquid crystal display device as claimed in claim 1, wherein the nano particle comprises a layer located on a surface of the nano particle, and the layer is made of poly acrylic resin.

8. A method for driving a cholesteric liquid crystal display device comprising the following steps:
providing a cholesteric liquid crystal display device, wherein the cholesteric liquid crystal display device comprises a first substrate, a second substrate, a cholesteric liquid crystal layer and a plurality of nano particles, the first substrate comprises a first alignment layer, the second substrate comprises a second alignment layer, the cholesteric liquid crystal layer is disposed between the first and second alignment layers, the nano particles are located between the first alignment layer and the cholesteric liquid crystal layer and/or between the second alignment layer and the cholesteric liquid crystal layer; and
applying a driving voltage to the cholesteric liquid crystal layer, wherein:
the cholesteric liquid crystal layer is in a first state when the driving voltage is a first voltage;
the cholesteric liquid crystal layer is in a second state when the driving voltage is increased and changed to a second voltage;
the cholesteric liquid crystal layer comes back to the initial first state when the driving voltage is decreased and changed to be the first voltage; and
when the cholesteric liquid crystal layer is operated within a driving voltage range between the first voltage and the second voltage, the driving voltage is increased or decreased in two-way operating direction, whereby the first state and the second state are mixed, and the ratio of the first state to the second state is different so as to show the gray-level of the cholesteric liquid crystal display device.

9. The method as claimed in claim 8, wherein the first and second states are a planar state and a focal conic state respectively, and the planar state and the focal conic state are a bright state and a dark state respectively.

10. The method as claimed in claim 8, wherein the nano particles are disposed on a surface of the second alignment layer and have a distribution density of 1 to 100 per square micrometer, and the size of the nano particle is between 20 and 1000 nanometers.
